(19) United States
(12) Patent Application Publication
(10) Pub. No.: US 2016/0302536 A1
(43) Pub. Date: Oct. 20, 2016

(54) Ball Chain Connection Apparatus

(71) Applicant: Nachman Deutsch, Monsey, NY (US)

(72) Inventor: Nachman Deutsch, Monsey, NY (US)

(21) Appl. No.: 14/993,956

(22) Filed: Jan. 12, 2016

Related U.S. Application Data
(60) Provisional application No. 62/147,794, filed on Apr. 15, 2015.

(51) Int. Cl. A44C 5/20; F16B 2/06

(52) U.S. Cl. CPC A44C 5/20; F16B 2/06

(57) ABSTRACT

A ball-shaped mechanism for connecting two ends of a ball chain. The mechanism is formed of two ball halves that may be separated to receive two link members and then secured together to hold the link members in place. Each of the ball halves has two opposing slots that are sized and shaped to receive a link member. When the two ball halves are brought together along their respective equatorial planes, the respective slots form pockets that secure link member ends within the ball-shaped connection mechanism.

### RELATED APPLICATIONS

This application claims the benefit of pending U.S. Prov. Pat. Appl. Ser. No. 62/147,794 filed Apr. 15, 2015, the contents of which are incorporated by reference herein.

### FIELD OF THE INVENTION

The invention relates to the field of tools and hardware parts, more specifically to a novel ball chain connection device.

### BACKGROUND OF THE INVENTION

Ball chains are commonly used for various household and industrial purposes. As an example, ball chains are frequently used to rotate a wheel inside of mechanical window shades, skylights or such similar devices. Ball chains are composed of essentially hollow balls having two diametrically opposed holes. Hollow balls are linked by respective linkage members that insert into a hole in one ball and a hole in a second ball thereby linking the two. Chains of various lengths may be assembled out of a series of balls and linkage members.

Linkage members are small cylindrical segments having a shaft that fits through holes in chain balls. The cylindrical segments have an enlargement on each terminal end. The enlargement is larger than respective holes in the balls and, as such, link ends are held securely within the confines of respective balls.

Conventional ball chains are a singular chain strand having a terminal ball on each end. To the extent that a circular chain or a loop is required, a ball chain connector is utilized to connect the terminal ends. Known ball chain connectors are metallic sleeves that are sized and shaped to capture two chain balls. in use, two terminal end balls of a chain are brought together and inserted into the connector, which holds the two ends together thereby turning a linear chain into a circular chain.

One problem associated with prior art connectors is that the sleeve is relatively long and inflexible. The chain segment containing the connector cannot be used to rotate a wheel or similar device because the connector will cause the chain to fall off track. As a result, in current use, ball chains that incorporate a connector have a limited range for use in turning a wheel.

There is therefore a need for a ball chain with a connector device that is not large and intrusive and which does not alter the exterior profile of a chain.

### SUMMARY OF THE INVENTION

The invention set forth herein is a chain connection mechanism consisting of two ball halves that combine to form a unitary “linking ball.” The linking ball connects two terminal chain ends using specialized internally incorporated slots or pockets avoiding the need for an external sleeve or connector. Because the inventive connector has the external shape of a ball, a chain connected with the inventive connector may be used on a pulley wheel or similar track without any restriction.

### BRIEF DESCRIPTION OF THE DRAWINGS

FIG. 1 is a perspective top exploded view of terminal chain ends and a linking ball according to an embodiment of the invention.

FIG. 2 is a top perspective view of a chain segment that is connected with a linking ball according to an embodiment of the invention.

FIG. 3 is a side cross-section view of a linking ball engaged to connect terminal ends of a chain according to an embodiment of the invention.

### DETAILED DESCRIPTION OF THE INVENTION

The following is a detailed description of the preferred embodiments of the invention, reference being made to the drawings in which the same reference numerals identify the same elements of structure in each of the several figures. It should be noted that these drawings are merely exemplary in nature and in no way serve to limit the scope of the invention.

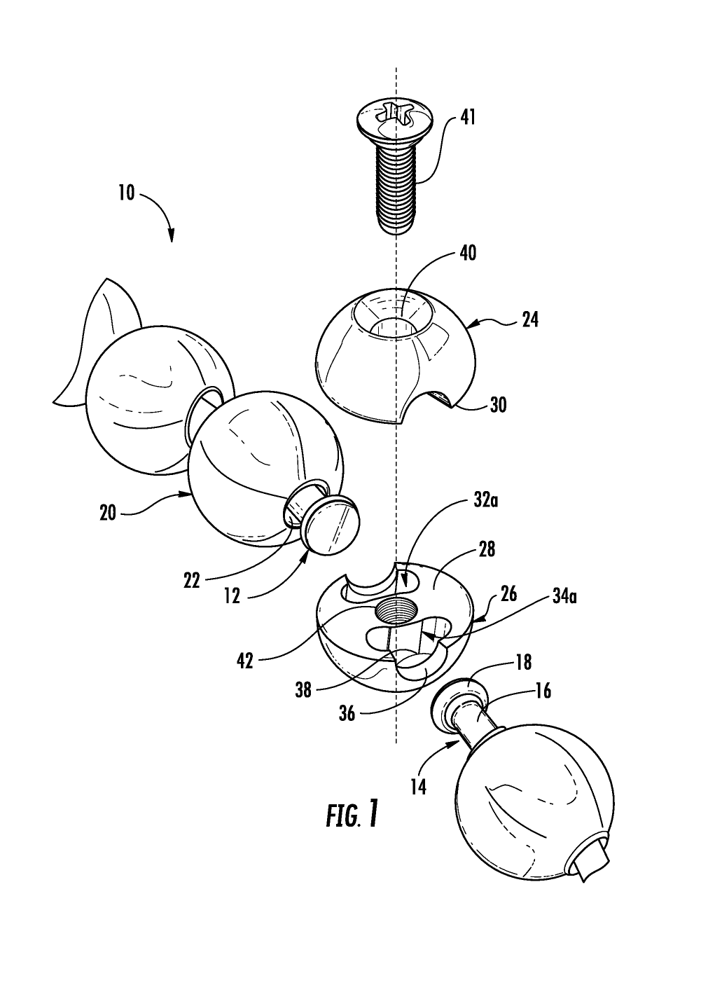

FIG. 1 shows an exploded view of the ball connector according to an embodiment of the invention. Two terminal ends of a chain 10 are shown with links (also “linkage members” herein) 12, 14 extending from each end thereof. As shown, each link (e.g. 14) has a cylindrical shaft section 16 and an enlargement 18 at each end thereof (only one end of each link is shown in FIG. 1). Enlargement 18, is a nub, a disc or spherical-shaped end or a similar feature having an exterior circumference or contour that is greater than that of shaft section 16. Respective links 12 insert into respective balls 20 through apertures 22 provided on balls 20. The circumference or perimeter of aperture 22 is slightly larger than the outside shaft 16 of link 14, but smaller than that of the outer contours of enlargements 18, so that once inserted, links cannot be removed from balls 20. Enlargements 18, as such, anchor respective links 12, 14 inside of respective balls 20 in order to form a linear chain.

The invention set forth herein is a specialized ball that is configured as a link between two balls.

FIG. 1 shows two cooperating ball halves that combine to form a linking ball. An upper ball half 24 and a lower ball half 26 are configured to capture and secure terminal ends of links 12, 14—thereby transforming a linear chain segment into a loop. As shown, lower ball half 26 is a substantially solid ball half or semi-sphere having a spherical exterior surface and an equatorial plane 28. Two diametrically opposed recesses, grooves or similar slots 32a, 34a are formed on ball half 26. Each slot 32a, 34a is substantially a reverse mold of a longitudinal cross-section of the terminal end of a link (including the enlargement and the end of a shaft section). That is, each slot (e.g. 34a) has an enlargement-receiving segment 38 that is sized and shaped to accommodate an enlargement 18 and a shaft-receiving segment 36 that is sized and shaped to receive a shaft segment 16 of a link 14.

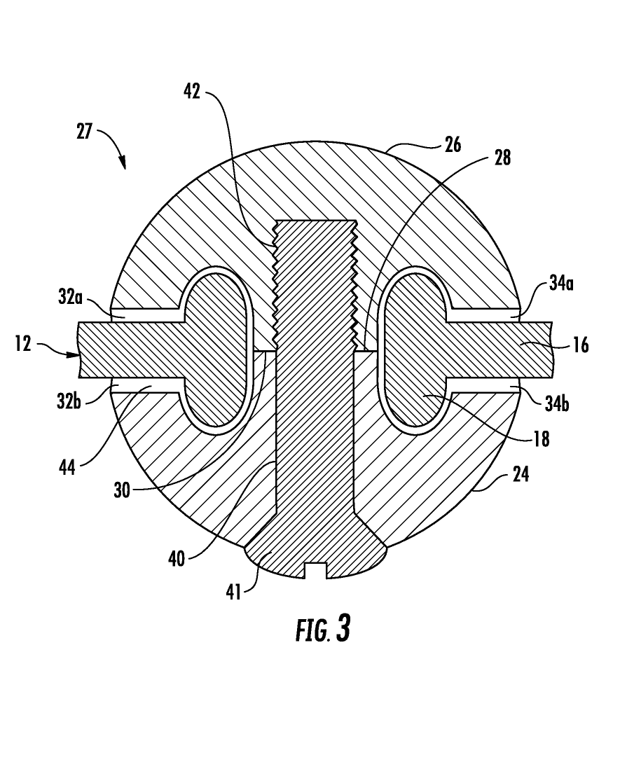

Upper ball half 24 substantially mirrors lower ball half 26 and it similarly has an equatorial plane 30 and diametrically opposed slots 32b, 34b (best shown in FIG. 3).

Respective ball halves 24, 26 have a connection mechanism for securing the two ball halves together in order to form a unitary linking ball. In one embodiment of the invention, respective ball halves 24, 26 are provided with cooperating channels to receive a screw. For example, as shown in FIG. 1, a hole or channel 40 opens on the exterior surface of upper ball half 24. Channel 40 is an elongated or tubular hole having rounded, unthreaded walls. Channel 40 spans through the thickness of ball half 24, and opens in the general center of its equatorial plane 30 (shown in cross-sectional view in FIG. 3). lower ball half 26 has a screw hole 42 that opens on equatorial plane 28 and extends into the thickness of the ball half 26. Screw hole 42 is a threaded channel that extends from the general center of equatorial plane 28 into at least a segment of the thickness of ball half 26.

In use, a user inserts two link ends (e.g. enlargements 18 on respective links 12, 14) into respective slots (e.g. 32a, 34a ) of a first ball half (e.g. 26) and then aligns a second ball half (e.g. 24) on top of the first one. A screw 41 is then inserted into channel 40 on the exterior of ball 24 such that the head of the screw reaches screw hole 42 on next ball half 26. Screw 41 is then rotated until its head is substantially flush with the exterior of ball half 24. Screw 41 threaded through connects the two ball halves 24, 26 to form a unitary linking ball 27.

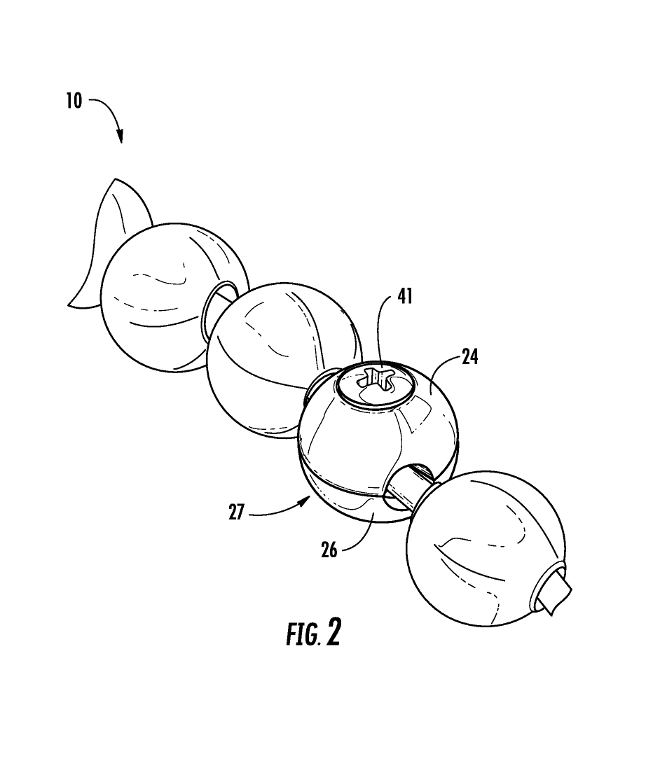

FIG. 2 shows a chain 10 that is connected with a linking ball 27 of the invention. As shown, upper ball half 24 is connected to lower ball half 26 via screw 41. When upper ball half 24 and lower ball half 26 are aligned, channel 40, and screw hole 42 line up to form a continuous hole for receiving screw 41. Screw 41 is shown fully traversed through channel 40 and driven through screw hole 42. When screw 41 is fully or partially threaded into screw hole 42 on lower ball half 26, the ball halves together are secured together.

The outside size and shape of unitary linking ball 27 is substantially the same as the other balls 20 on chain 10 such that when a chain loop is formed using linking bail 27, each ball in the chain substantially has the same profile. As such, the entire distance of a chain loop connected with the inventive linking ball is available for use. For example, an entire chain loop may be used to turn a pulley wheel, whereas, with the prior art connection sleeves, the chain segment containing the connection sleeve could not be used to turn the wheel. Moreover, because the entire distance of the chain loop could be used, a chain that is connected with the inventive linking ball could be configured to make several rotations around a wheel thereby allowing smaller chain loops than was otherwise necessary with the prior art chains connected with a sleeve.

FIG. 3 shows a cross-sectional view of a linking ball 27 connecting terminal ends of a chain according to an embodiment of the invention. As shown, respective equatorial planes 28, 30 are substantially parallel to one another and respective channel 40 and screw hole 42 form a continuous channel from the outer surface of ball half 24 through an interior surface of ball half 26. Screw 41 inserted through channel 40 and driven through screw hole 42 holds the ball halves 26, 24 tightly joined together with respective equatorial planes 28, 30 contacting one another. When the ball halves 26, 24 are joined together, slot 32a aligns with slot 32b and slot 34a aligns with slot 34b to form respective unitary pockets that are sized and shaped to accommodate the outer contours of respective link ends (i.e. enlargements 18 and terminal shaft ends 16).

As shown, in FIG. 3, substantially half of the thickness of the link 12 projects upwardly from equatorial plane 30. A second, substantially mirror image ball half 26 applied over first ball half 24 such that the two ball halves 24, 26 line up to encapsulate respective enlargements 18 of links extending from respective terminal balls and maintain them securely therein. As shown, enlargement-receiving segments of respective balls aligned in a mirroring orientation create a pocket that houses enlargement 18 and respective mirror-aligned shaft-receiving segments create a channel or aperture through which shaft segment 16 of a link exits out of linking ball 27. The circumference of the aperture formed by the respective shaft-receiving segments is smaller than that of the circumference or outer contours of enlargements 18. As such, enlargements 18 held within the unitary pockets formed by the aligned enlargement-receiving sections 38 cannot exit out of the apertures formed by the aligned shaft-receiving sections 36 because the formed apertures have a circumference or perimeter that is smaller than that of the enlargements 18. Thus, when the two ball halves 24, 26 are joined together with respective enlargements 18 held within the two unitary pockets formed the links become anchored in linking ball 27. (It should be noted that the terms “slot” is used to refer to a recessed area in a ball half having an enlargement-receiving area and a shaft-receiving area. When respective slots on respective ball halves align a “unitary pocket” is formed. A unitary pocket is a continuous pocket formed by two slots that is sized and shaped to surround an enlargement. Two shaft-receiving areas of two opposing ball halves align to form an aperture through which a shaft of a link member exits the linking ball.)

It should be noted that the depth of each enlargement-receiving section 38 of slots 32a, 34a, 32b, 34b is incrementally greater than half of the thickness of an enlargement 18. Similarly, each shaft-receiving section 36 of slots 32a, 34a, 32b, 34b is incrementally greater than half of the thickness of a shaft 16 of a link. As such, when ball halves 26, 24 are aligned and connected, the pockets formed to capture enlargements 18 are slightly larger than the outer contours of enlargements, and the apertures formed to surround shafts 16 are slightly larger than the outer contours of enlargements. This provides links 12 with a degree of freedom to move in all directions while encapsulated within the confines of the unitary pockets formed. For example, FIG. 3 shows an area of clearance 44 between the outside of link 12 and the interior of slots 32a, 32b.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A chain connection apparatus, comprising:
a first ball half having a spherical exterior surface and an equatorial plane;
a second ball half having a spherical exterior surface and an equatorial plane;
said equatorial plane on said first ball half comprising a first slot and a second slot, each of said first and second slots having an enlargement-receiving section that are sized and shaped to receive substantially half the height of an enlargement provided on a link member;
said equatorial plane on said second ball half comprising a first slot and a second slot, each of said first and second slots having an enlargement-receiving section that are sized and shaped to receive substantially half the height of an enlargement provided on a link member;
whereby said first slot on said first ball half aligns with said first slot on said second ball half to form a first pocket that is sized and shaped to receive an enlargement on a link member and said second slot on said first ball half aligns with said second slot on said second ball half to form a second pocket that is sized and shaped to receive an enlargement on a link member.

2) The chain connection apparatus of claim 1, whereby said first slot on said first ball half is disposed substantially diametrically opposed from said second slot on said first ball half.

3) The chain connection apparatus of claim 1, whereby said first slot on said second ball half is disposed substantially diametrically opposed from said second slot on said second ball half.

4) The chain connection apparatus of claim 1, whereby said first slot and said second slot on said first ball half further comprise a shaft receiving section, said shaft-receiving section comprising a grooved area that is sized and shaped to receive a segment of a shaft on a link member, and said first slot and said second slot on said second ball half further comprise a shaft receiving section, said shaft-receiving section comprising a grooved area that is sized and shaped to receive a segment of a shaft on a link member.

5) The chain connection apparatus of claim 4 whereby said shaft receiving sections of said first and second slots on said first ball half align with said shaft receiving sections of said first and second slots on said second ball half to form respective first and second apertures.

6) The chain connection apparatus of claim 5, whereby an enlargement of a first link member is held in said first pocket and an enlargement of a second link member is held in said second pocket whereby a shaft of said first link member projects out of said first aperture and a shaft of said second link member projects out of a said second aperture.

7) The chain connection apparatus of claim 1, further comprising a channel disposed between said spherical exterior surface of said first ball half and said equatorial plane of said first ball half, whereby said screw has an opening on each of said spherical exterior surface and said equatorial plane.

8) The chain connection apparatus of claim 7, further comprising a screw hole on said second ball half, said screw hole opening on said equatorial plane on said second ball half and extending into a segment of a thickness of said second ball half.

9) The chain connection apparatus of claim 8, whereby said channel on said first ball half aligns with said screw hole on said second ball half when said first equatorial plane is brought into contact with said second equatorial plane to form a continuous hole.

10) The chain connection apparatus of claim 9, further comprising a screw threaded through said continuous hole.
